(19) United States
(12) Patent Application Publication
(10) Pub. No.: US 2008/0123673 A1
(43) Pub. Date: May 29, 2008

(54) METHOD FOR TRANSMITTING PACKET AND SYSTEM FOR MOBILE COMMUNICATION THEREOF AND MOBILE STATION

(75) Inventor: Chi-Chen Lee, Taipei City (TW)

Correspondence Address: J C PATENTS, INC., 4 VENTURE, SUITE 250, IRVINE, CA, 92618, US

(73) Assignee: INDUSTRIAL TECHNOLOGY RESEARCH INSTITUTE, Hsinchu (TW)

(21) Appl. No.: 11/756,895

(22) Filed: Jun. 1, 2007

(30) Foreign Application Priority Data
Nov. 24, 2006 (TW) 95143500

(51) Int. Cl. H04L 12/56

(52) U.S. Cl. 370/412

(57) ABSTRACT

A method for transmitting packet is disclosed. The method is adopted in a system for mobile communication and the system including a mobile station and a network providing connection-oriented service. After optimizing the packet sequence number according to the connection service characteristics and the downlink packet sequence number in the mobile station and the network providing connection-oriented service, the out-of-date packets are deleted. Therefore, the transmission and retransmission of the out-of-date packets may be avoided and thereby reduce delays and decrease required bandwidth.

### CROSS-REFERENCE TO RELATED APPLICATION

This application claims the priority benefit of Taiwan application serial no. 95143500, filed on Nov. 24, 2006. All disclosure of the Taiwan application is incorporated herein by reference.

### BACKGROUND OF THE INVENTION

1. Field of the Invention

The present invention is generally related to a mobile communication system with broadband wireless access, and more particularly, to a method for transmitting packet that a mobile station uses during handover in a network providing connection-oriented service, and a mobile communication system thereof and the mobile station.

2. Description of Related Art

With the advancement of network technique and the rapid development in electron science and technology, there is a remarkable increase in demand for various data, and the request for transmission rate in network is increasingly demanded. In a mobile communication system with a general broadband wireless access, the waste of bandwidth and the delays of wait time are often caused during handover because the out-of-date packets are forwarded and retransmitted in forwarding and retransmission mechanism. In other words, in real-time service, when a client side receives a packet data, the packet data will be rejected if its delay exceeds an allowance. Thus, not only the transmission bandwidth is wasted, but also the transmission of subsequent packets is delayed due to the out-of-date packets.

FIG. 1 illustrates a schematic flow chart of a conventional method for transmitting packet during handover. Referring to FIG. 1, the system includes a mobile station 101, a serving base station/relay station 103, and a target base station/relay station 105.

After the mobile station 101 have received a downlink packet data 107 from the original serving base station/relay station 103, if the mobile station 101 is to be handed over from the serving base station/relay station 103 to the target base station/relay station 105, the mobile station 101 will transmit a handover notification message 109 to the serving base station/relay station 103 to inform the original serving base station/relay station 103 that the mobile station 101 will be handed over to the target base station/relay station 105.

Meanwhile, the mobile station 101 will also transmit an entering network request message 111 to the target base station/relay station 105 to inform the target base station/relay station 105 that the mobile station 101 will connect thereto. Thereafter, in order to reduce the procedure for the mobile station 101 entering network and to optimize handover, the target base station/relay station 105 queries the serving base station/relay station 103 for data of the mobile station 101 through a mobile station information request message 113. Next, the serving base station/relay station 103 transmits the information of the mobile station 101 back to the target base station/relay station 105 through a mobile station information response message 115.

In succession, the target base station/relay station 105 transmits an entering network response message 117 to the mobile station 101 to inform the mobile station 101 of the permission to found connection. Thereafter, there may be some other additional steps of entering network 119 because of the different optimization level of handover.

After the handover is completed, the mobile station 101 informs the target base station/relay station 105 of the highest sequence number of the downlink packet data that the current connections are expecting to receive, through a sequence number report message 121. In addition, through a buffering data request message 123, the target base station/relay station 105 requests the serving base station/relay station 103 to forward all the packets after the packet sequence number reported by the mobile station 101 to the target base station/relay station 105, according to the sequence number report message 121 transmitted by the mobile station 101. Thereafter, the serving base station/relay station 103 forwards the packet data to the target base station/relay station 105 through a forwarding packet data 125. Finally, the target base station 105 may transmit a downlink packet data 127 to the mobile station 101, transmitting or retransmitting the packet data that have not been received before handover.

In the conventional method, it is not determined whether the packet data is out of date when the serving base station/relay station 103 forwards the packet data 125 to the target base station/relay station 105, or the mobile station 101 transmits the sequence number report message 121 to the target base station/relay station 105. Thus the out-of-date packets may be transmitted or retransmitted when forwarding the packet data 125 and transmitting the downlink packet data 127. This causes the waste of bandwidth, as well as the transmission delay of the non-out-of-date packets subsequently transmitted, thereby adversely affecting the connection quality of real-time service.

### SUMMARY OF THE INVENTION

The present invention is directed to a method for transmitting packet in a network providing connection-oriented service (hereinafter referred to as connection-oriented network) in a mobile communication system. In the method, according to the connection service characteristics and the downlink packet sequence number, the out-of-date packets are deleted in the network providing connection-oriented service, so that the transmission delays of the subsequent real-time service packets, due to the transmission or retransmission of the out-of-date packets, can be avoided.

The present invention is also directed to a method for transmitting packet in a mobile station in a mobile communication system. In the method, a downlink packet sequence number is obtained by optimizing the packet sequence number to be reported. Next, a downlink packet data is received according to the downlink packet sequence number to avoid wasting bandwidth transmitting or retransmitting the out-of-date packets.

The present invention is also directed to a mobile communication system, in which optimization of packet sequence number can be performed on each side of a connection-oriented network and a mobile station to avoid forwarding the out-of-date packets in the connection-oriented network and transmitting the out-of-date packets between the connection-oriented network and the mobile station during handover.

The present invention is also directed to a mobile station, in which, after optimizing the packet sequence number to be reported using a handover process control unit, the highest sequence number of the non-out-of-date downlink packet data that the current connection is expecting to receive is obtained.

As embodied and broadly described herein, the present invention provides a method for transmitting packet in a mobile communication system. In the method, a packet data in a schedule queue is transmitted. The transmitted packet data is buffered to a retransmission queue. A downlink packet sequence number report is received. Out-of-date packet data in the retransmission queue is determined according to a connection service characteristics belonging to current packet data being transmitted and the downlink packet sequence number report. Out-of-date packet data in the schedule queue is determined according to the connection service characteristics belonging to the current packet data being transmitted and the downlink packet sequence number report. Non-out-of-date packet data in the retransmission queue and the schedule queue is scheduled and transmitted.

As embodied and broadly described herein, the present invention provides a method for transmitting packet in a mobile communication system including a mobile station and a network providing connection-oriented service including a first service station and a second service station. In the method, a handover notification message is received by the first service station. An entering network request message is received by the second service station. An entering network response message is responded by the second service station. A sequence number report message including a downlink packet sequence number is received by the second service station. A real-time or a non-real-time packet sequence number, or a real-time and a non-real-time packet sequence number is optimized by the first service station to obtain an optimized forwarding packet sequence number according to connection service characteristics belonging to current packet data being transmitted and the corresponding downlink packet sequence number. The packet data is forwarded to the second service station by the first service station according to the optimized forwarding packet sequence number. A downlink packet data is transmitted by the second service station.

As embodied and broadly described herein, the present invention provides a method for transmitting packet in a mobile communication system, wherein the mobile communication system includes a mobile station and a network providing connection-oriented service including a first service station and a second service station. In the method, a handover notification message is received by the first service station. An entering network request message is received by the second service station. An entering network response message is responded by the second service station. A sequence number report message including a downlink packet sequence number is received by the second service station. A real-time or a non-real-time packet sequence number, or a real-time and a non-real-time packet sequence number to be transmitted is optimized by the second service station to obtain an optimized transmitting packet sequence number according to a connection service characteristics belonging to current packet data being transmitted and the corresponding downlink packet sequence number. A downlink packet data is transmitted by the second service station according to the optimized transmitting packet sequence number.

As embodied and broadly described herein, the present invention provides a method for transmitting packets in a mobile communication system, wherein the mobile communication system includes a mobile station and a network providing connection-oriented service including a first service station and a second service station. In the method, a handover notification message is received by the first service station. An entering network request message is received by the second service station. An entering network response message is responded by the second service station. a real-time packet sequence number to be forwarded is optimized by the first service station to obtain an optimized forwarding packet sequence number according to a connection service characteristics belonging to current packet data being transmitted. A real-time service packet data is transmitted to the second service station by the first service station according to the optimized forwarding packet sequence number. A sequence number report message including a downlink packet sequence number is received by the second service station. The real-time service packet data is transmitted by the second service station.

As embodied and broadly described herein, the present invention provides a system for mobile communication. The system includes a mobile station and a network providing connection-oriented service. The network includes a first service station and a second service station. The mobile station transmits or receives a handover notification message and transmits an entering network request message. The first service station receives or transmits the handover notification message. The second service station receives the entering network request message and responds to the mobile station with an entering network response message. The second service station receives a sequence number report message including a downlink packet sequence number transmitted by the mobile station. The first service station optimizes a real-time packet sequence number to be forwarded according to a connection service characteristics belonging to current packet data being transmitted and the corresponding downlink packet sequence number to obtain an optimized forwarding packet sequence number, and transmits a packet data to the second service station according to the optimized forwarding packet sequence number so that the second service station transmits a downlink packet data to the mobile station.

As embodied and broadly described herein, the present invention provides a mobile station including a receiver, a service characteristics management calculation unit, a handover process control unit and a transmitter. The receiver receives data of a plurality of protocol data units. The service characteristics management calculation unit provides and maintains connection service characteristics including a connection service type or a connection service quality parameter or a connection statistical information or combination thereof. The service characteristics management calculation unit is coupled to the receiver to collect connection statistical information according to data received by the receiver, and calculates and maintains the connection statistical information. The handover process control unit is coupled to the service characteristics management calculation unit for obtaining the connection service characteristics after handover and optimizing the packet sequence number to be reported according to the connection service type to obtain a downlink packet sequence number. The transmitter transmits a sequence number report message including the downlink packet sequence number.

As embodied and broadly described herein, the present invention provides a method for transmitting packet in a mobile station in a system for mobile communication. In the method, data of a plurality of protocol data units is received. A connection service characteristics is collected according to the received data; and the connection service characteristics including a connection service type or a connection service quality parameter or a connection statistical information, or combination thereof is calculated and maintained. A sequence number of a packet to be reported is optimized according to the connection service type to obtain a downlink packet sequence number. A sequence number report message including the downlink packet sequence number is transmitted.

These and other exemplary embodiments, features, aspects, and advantages of the present invention will be described and become more apparent from the detailed description of exemplary embodiments when read in conjunction with accompanying drawings.

### BRIEF DESCRIPTION OF THE DRAWINGS

FIG. 1 illustrates a schematic flow chart of a conventional method for transmitting packets during handover.

FIG. 2 illustrates a mobile communication system according to one embodiment of the present invention.

FIG. 3 is a schematic flow chart illustrating a method for transmitting packet according to one embodiment of the present invention.

FIG. 4 is a schematic flow chart illustrating a method for transmitting packet according to another embodiment of the present invention.

FIG. 5 is a schematic flow chart of a method for transmitting packet illustrated according to another embodiment of the present invention.

FIG. 6 is a schematic flow chart of a method for transmitting packet illustrated according to yet another embodiment of the present invention.

FIG. 7 is a block diagram of a mobile station illustrated according to an embodiment of the present invention.

FIG. 8 is a schematic flow chart of a method for transmitting packet illustrated according to another embodiment of the present invention.

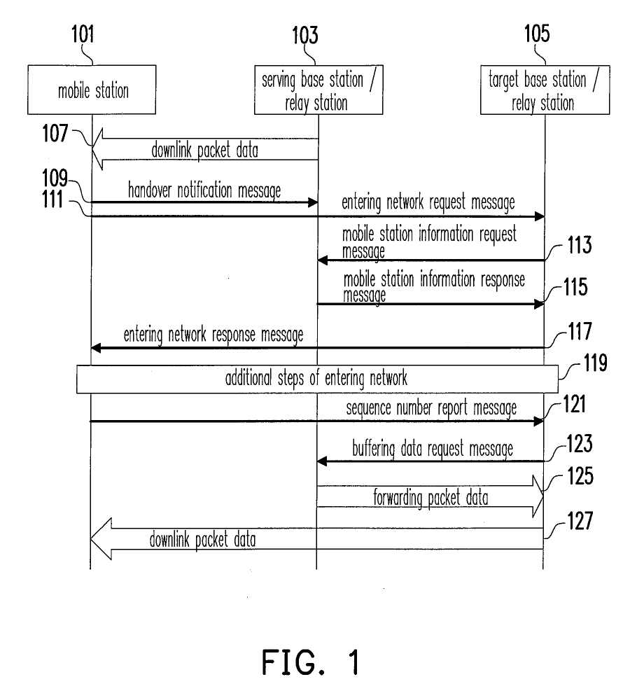

### DESCRIPTION OF EMBODIMENTS

In a network providing connection-oriented service, a mobile station will encounter temporary interruption of communication due to handover, which will affect the real-time service to some extent. Therefore, in the present invention, a mechanism of optimization is designed at each side of the network providing connection-oriented service and the mobile station to avoid the transmission and retransmission of the out-of-date packets. To clarify the disclosure of the invention, various embodiments are provided as examples, which are not intended to limit the scope of the present invention.

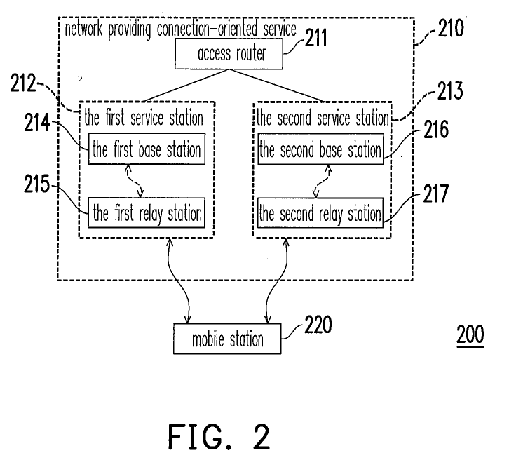

FIG. 2 illustrates a mobile communication system according to an embodiment of the present invention. Referring to FIG. 2, in the present embodiment, the mobile communication system 200 includes a network 210 providing connection-oriented service (hereinafter referred to as connection-oriented network) and a mobile station 220. The connection-oriented network 210 comprises an access router 211, a first service station 212, and a second service station 213.

As shown in FIG. 2, the mobile station 220 is used to transmit a handover notification message and an entering network request message to the connection-oriented network 210 when the mobile station 220 is moving in different areas covered by the different service stations. The first service station 212 and the second service station 213 described above further includes a first base station 214 and a first relay station 215, and a second base station 216 and a second relay station 217, respectively. Wherein, the communication between the base stations and the relay stations may be wireless communication or wired communication, and the relay stations are used to assist signal transmission between the base stations and the mobile station 220. Furthermore, the first service station 212 is the service station connected to the original mobile station 220 before handover, while the second service station 213 is the target service station that the mobile station 220 is to be handed over thereto.

The access router 211 is used to transmit packet data between the first service station 212 and the second service station 213 in the connection-oriented network 210. In other words, the access router 211 may be used to connect two service stations and to transmit packet data between the two service stations. The first service station 212 is used to receive a handover notification message transmitted by the mobile station 220. In addition, the second service station 213 is used to receive an entering network request message transmitted by the mobile station 220, and to respond to the mobile station 220 with an entering network response message. The second service station 213 also receives a sequence number report message, including the downlink packet sequence numbers of the connections, reported by the mobile station 220.

The above-mentioned downlink packet sequence number is obtained by the mobile station 220 by optimizing the packet sequence number to be reported according to the connection service characteristics belonging to the current downlink packet data being received. The connection service characteristics is, for example, connection service type, parameters of connection quality of service (QoS), and connection statistical information, etc.

The first service station 212 optimizes the real-time packet sequence number to be forwarded to the second service station according to the connection service characteristics belonging the current packet being transmitted and the downlink packet sequence number reported by mobile station 220 (this is not required when the forwarding is made ahead of time), and then forwards the packet data to the second service station 213 directly or via the access router 211, so that the second service station 213 transmits the downlink packet data to the mobile station 220.

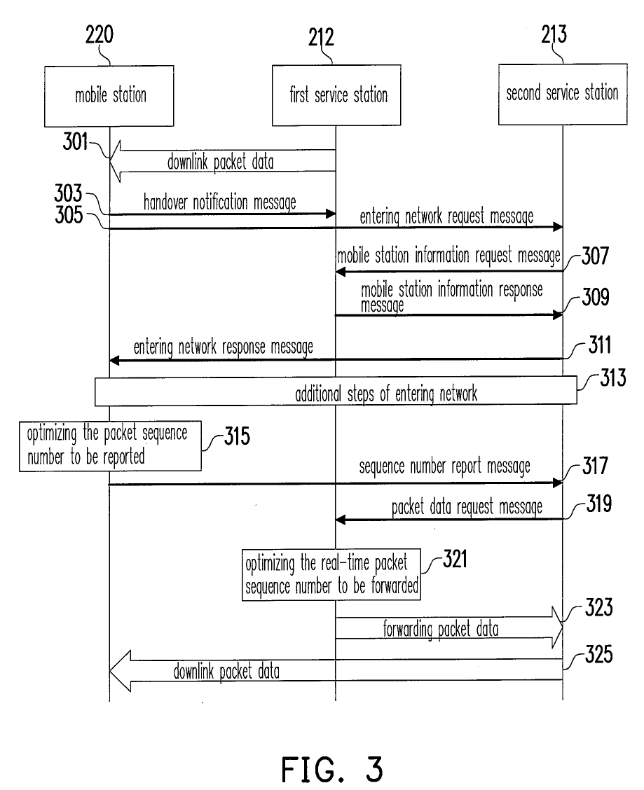

FIG. 3 is a schematic flow chart illustrating a method for transmitting packet according to an embodiment of the present invention. Referring to FIG. 3, the first service station 212 performs the operation 321 of optimizing the packet sequence number. First, the mobile station 220 receives the downlink packet data 301 from the first service station 212. When the mobile station 220 is to be handed over from the first service station 212 to the second service station 213, the mobile station 220 will inform the first service station 212 that it is to be handed over to the second service station 213 through the handover notification message 303. Furthermore, the handover notification message may also be transmitted to the mobile station 220 (not shown) by the first service station 212. Meanwhile, the mobile station 220 transmits an entering network request message 305 to the second service station 213 requesting for connection with the second service station 213.

Meanwhile, in order to achieve optimization to reduce the procedure that the mobile station 220 re-enters the network, the second service station 213 transmits a mobile station information request message 307 to the first service station 212 to query for data of the mobile station 220 from the first service station 212. Next, the first service station 212 transmits the data of the mobile station 220 back to the second service station 213 via a mobile station information response message 309. In addition, after the second service station 213 transmits an entering network response message 311 to the mobile station 220 to permit connection with it, there may be other additional steps 313 for entering network in the mobile station 220 and the second service station 213 because of the different optimization level of handover.

When the procedure of entering network is completed, the mobile station 220 may, after optimizing the packet sequence number to be reported (315) according to the connection service characteristics (for example, connection service type, parameters of connection service quality, and connection statistical information, etc.) belonging to the received current downlink packet data, obtain the downlink packet sequence number. The optimization 315 includes determining connections (both real-time and non-real-time service) that need to report packet sequence number. The mobile station 220 sequentially transmits the optimized downlink packet sequence number to the second service station 213 via the sequence number report message 317 to inform the second service station 213 of the highest sequence number of the downlink packet sequence number that the current connection is expecting to receive. Meanwhile, the second service station 213 requests the first service station 212 to forward a buffering downlink packet belonging to the mobile station 220 through the packet data request message 319.

The first service station 212 sequentially optimizes the real-time packet sequence number to be forwarded (321) to obtain an optimized forwarding packet sequence number according to the connection service characteristics belonging to the current packet data belonging to the mobile station, and the downlink packet sequence number. Next, the first service station 212 forwards the packet data 323 to the second service station 213 according to the obtained forwarding packet sequence number described above. The second service station 213 then forwards the downlink packet data 325. In this way, the mobile station 220 can continue to receive or re-receive the un-received data before handover.

It should be noted that the operation of optimization 315 of the packet sequence number to be reported in the mobile station 220 may be or may not be executed in this embodiment. Since the operation of optimization 321 of the real-time packet sequence number to be forwarded in the first service station 212 can reduce the delay of subsequent real-time service packet, whether to optimize the mobile station 220 is as the case may be.

Furthermore, the optimization of sequence number mentioned in the present embodiment refers to how to determine whether the packets in the schedule queue and the retransmission queue are out of date. The optimization is based on the following formulas, wherein the side of network (connection-oriented network) uses the formula (1) and (3), while the mobile station uses the formula (2), (3), and (4):

$$\begin{matrix}{T}_{etd\_N} = \begin{matrix}{T}_{cqd\_N} + {T}_{eld} + {T}_{ehd} + {T}_{ecd} + {T}_{epd} + {T}_{eqd} \\ {T}_{emd} + {T}_{erd} + {T}_{esd} + {T}_{efd} + {T}_{ejd} ;\end{matrix} & ( 1 ) \\ {T}_{etd\_N} = {T}_{cp\_N} + {T}_{cw\_N} + {T}_{espd} + {T}_{end} ; & ( 2 ) \\ ⌈ \frac{{T}_{etd\_N}}{{T}_{f}} ⌉ \cdot {T}_{f} < {T}_{qosd} ; & ( 3 ) \\ {T}_{cw\_N} < {T}_{inactv} . & ( 4 )\end{matrix}$$

Wherein, the parameters include estimated total delays of packet numbered as N (T_{etd}_{_{—}}_{N}), frame duration (T_{f}), cumulated process time of service data unit (SDU) denoted as N (T_{cp}_{_{—}}_{N}), cumulated wait time of SDU denoted as N (T_{cw}_{_{—}}_{N}), connection inactive time (T_{inactiv}), current queuing delays of the packet denoted as N (T_{cqd}_{_{—}}_{N}), delay requirement of QoS service type belonging to the packet (T_{qosd}), estimated handover delays (T_{ehd}), estimated relay delays (T_{eld}), estimated codec processing delays (T_{ecd}), estimated packetization delays (T_{epd}), estimated queuing delays (T_{eqd}), estimated modulation & demodulation delays (T_{emd}), estimated radio frame wait times (T_{erd}), estimated serial transmission time (T_{esd}), estimated IP Router & Switch forwarding delays (T_{efd}), estimated receive jitter buffer delays (T_{ejd}), estimated SDU processing delay (T_{espd}), and estimated network processing delay (T_{end}).

The above formulas (1), (2), and (3) are utilized to calculate whether the packet numbered as N is out of date. The formula (4) is used to determine whether a connection exceeds the inactive time. If the connection exceeds the inactive time, the packet sequence number of the connection need not be reported. First, as shown in formula (1), the current queuing delays of the packet numbered as N (T_{cqd}_{_{—}}_{N}) and all the possible delays that may occur in processing and transmitting the out-of-date packets after handover must be added up. Except for the T_{cqd}_{_{—}}_{N}, which is an actual measured value, the remaining are predicted values. In the formula (2), the current cumulated process time (T_{cp}_{_{—}}_{N}) and cumulated wait time (T_{cw}_{_{—}}_{N}) of SDU and all the possible delays (T_{espd}, T_{end}) during handover must be added up. Except for the T_{cp}_{_{—}}_{N} and T_{cw}_{_{—}}_{N}, which are actual measured values, the remaining are predicted values. In addition, if the value T_{etd}_{_{—}}_{N} obtained from the addition is under a frame based system, the delays take ‘frame size’ as unit, and therefore the T_{etd}_{_{—}}_{N} must be divided by the frame duration (T_{f}), and then after the obtained value enters unconditionally, it is multiplied by the T_{f} so that the T_{etd}_{_{—}}_{N} takes ‘frame size’ as unit, as shown as the equation

$$( ⌈ \frac{{T}_{etd\_N}}{{T}_{f}} ⌉ \cdot {T}_{f} )$$

on the left side of the formula (3).

Whether the packet is out of date is determined based on the formula (3), and if the packet does not satisfy the equation (3), it will be sequentially deleted. For example, if the value, with frame size as unit, obtained from the packet denoted as N through calculating via the formula (1) is less than T_{qosd}, the sequence number N will be retained. Otherwise, the sequence number N is an out-of-date packet and will be deleted. In the formula (4), whether to report the next packet sequence number that the connection is waiting for is determined by determining whether the cumulated wait time of SDU denoted as N (T_{cw}_{_{—}}_{N}) exceeds the connection inactive time (T_{inactv}). The second service station 213 can learn the connection activity of the MS from the first service station 212 and, therefore, will not expect the downlink sequence number report from MS.

It should be noted that in the above-mentioned determination step, a check is not required for all the packet sequence numbers. Whereas, the check begins in the order of from the lowest number and stops until a packet that satisfies the demand appears. The lowest number represents the earliest sequence number that reaches the queue, therefore all the sequence numbers thereafter will satisfy the demand. Furthermore, the way of numbering packet mentioned in the present embodiment refers to numbering the whole packet when the packet reaches the queue, and thereafter the packet will not be further numbered regardless how many times the packet being divided.

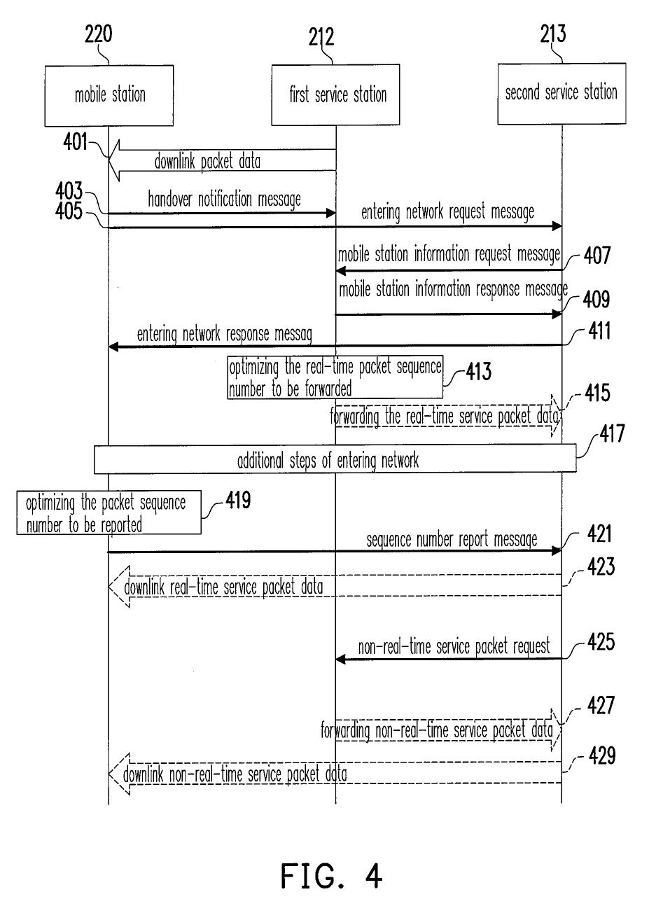

FIG. 4 is a schematic flow chart of a method for transmitting packet illustrated according to another embodiment of the present invention. Referring to FIG. 4, the point of time of optimizing the real-time packet sequence number (413) to be forwarded is made ahead of time so that the delay of the packet is further reduced. When the mobile station 220 is to be handed over from the first service station 212 to the second service station 213, the details of the steps 401˜411 are the same as or similar to the handover steps 301˜311 in the aforementioned embodiment, thus the details will not be repeated hereinafter.

After the second service station has responded to the mobile station 220 with an entering network response message 411, the first service station 212, according to the connection service characteristic belonging to the packet to be forwarded optimizes the real-time packet sequence number (413) to be forwarded to obtain a forwarding packet sequence number, and then forwards the real-time service packet 415 to the second service station 213 according to the forwarding packet sequence number. There is strict limit of packet delay to real-time service, therefore in the present embodiment, i.e. for real-time service, the point of time of forwarding the real-time service packet (415) is made ahead of time, thus the packet delay is further reduced.

Meanwhile, there may be other additional steps for entering network 417 for the mobile station 220 and the second service station 213 because of the different optimization level due to handover. When the connection is founded, the mobile station 220 may, after optimizing the packet sequence number (419) to be reported according to the connection service characteristics belonging to the current packet being transmitted, obtain the downlink packet sequence number. Next, the mobile station 220 transmits the downlink packet sequence numbers of the connections to the second service station 213 through the sequence number report message 421 to inform the second service station 213 of the highest sequence number of the downlink packet sequence numbers that the current connection is expecting to receive.

When the second service station 213 receives the sequence number report message 421 transmitted by the mobile station 220, the second service station 213 will downlink the real-time service packet data 423. Next, the second service station 213 transmits a non-real-time service packet request 425 to the first service station 212 to request the first service station 212 to forward a non-real-time service packet message belonging to the mobile station 220. Meanwhile, the first service station 212 will forward a non-real-time service packet data 427 to the second service station 213, and then the second service station 213 may downlink a non-real-time service packet data 429 to the mobile station 220.

It should be noted that the operation of optimizing the downlink packet sequence number (419) to be reported by the mobile station 220 may be or may not be executed in this embodiment. Since the operation of optimizing the real-time packet sequence number (413) to be forwarded in the first service station 212 has reduced the delays of subsequent real-time service packets, and the point of time of optimization is made ahead of time to further greatly reduce the delays of subsequent packets, whether to optimize the mobile station 220 is as the case may be.

It should be noted that the operation of optimizing the sequence number is based on the formulas (1) and (3). The two formulas are the same as or similar to that of the aforementioned embodiment, and therefore the detail description thereof will not be repeated hereinafter.

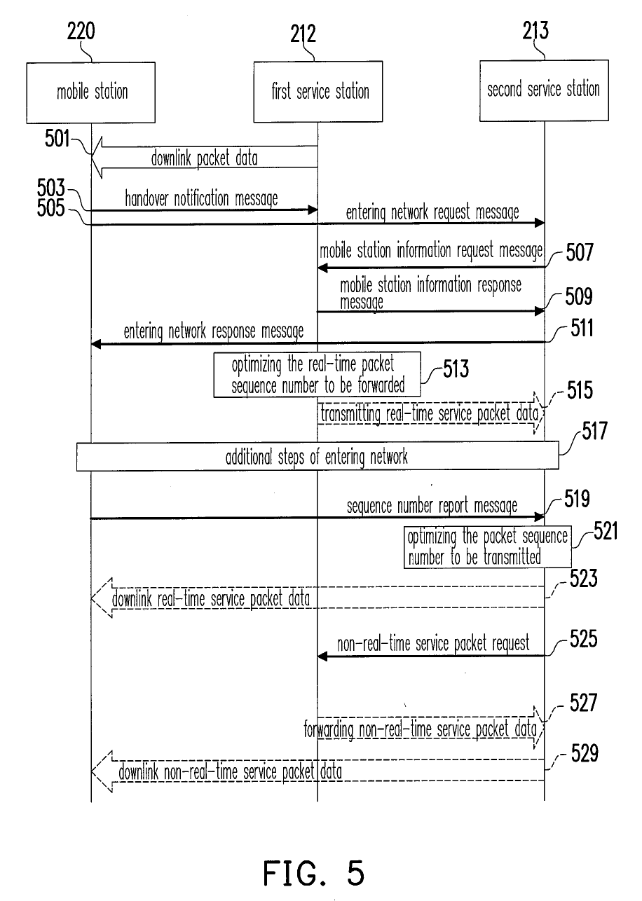

FIG. 5 is a schematic flow chart of a method for transmitting packet illustrated according to another embodiment of the present invention. Referring to FIG. 5, the mobile station 220 need not optimize the packet sequence number to be reported, while in the second service station 213, optimization is performed according to the connection service characteristics. Wherein, when the mobile station 220 is handed over from the first service station 212 to the second service station 213, the details of the steps 501˜511 are the same as or similar to the steps 301˜311 in the aforementioned embodiment, and therefore detail description thereof will not be repeated hereinafter.

For real-time service, the point of time of transmitting real-time service packet 515 is made ahead of time. Being the same as the 415 of the above-mentioned embodiment, the first service station 212, after optimizing the packet sequence number (513) to be forwarded according to the connection service characteristics belonging to the current packet being transmitted, forwards the real-time service packet data 515 to the second service station 213 according to the obtained forwarding packet sequence number. Meanwhile, there may be other additional steps for entering network (517) in the mobile station 220 and the second service station 213 due to the different optimization level of handover.

When the connection is found, the second service station 213 receives a sequence number report message 519 transmitted from the mobile station 220, and then optimizes the real-time packet sequence number (521) to be transmitted according to the connection service characteristics belonging to the current packet being transmitted and the downlink packet sequence number, to obtain a transmitting packet sequence number. The second service station 213 performs optimization according to the connection service characteristics and determines whether the current sequence number report message 519 that the mobile station 220 reports to receive is out of date, to obtain a transmitting packet sequence number. Next, the second service station 213 transmits the non-out-of-date packets in the queue and downlinks the packets according to the transmitting packet sequence number.

Wherein, the downlink packets include downlink real-time service packets 523 and downlink non-real-time service packets 529. Steps 523˜529 are the same as or similar to the steps 423˜429 in the above-described embodiment, and therefore detail description thereof will not be repeated hereinafter. Furthermore, the operation of optimizing the sequence number is based on the formula (1) and (3), which are the same as that of the aforementioned embodiment, and therefore detail description thereof will not be repeated hereinafter.

It should be noted that the operation of optimizing the real-time packet sequence number (521) to be transmitted by the second service station 213 can reduce the delays of subsequent packets in the present embodiment. Consequently, whether to optimize the packet sequence number (513) to be forwarded by the first service station 212 is as the case may be.

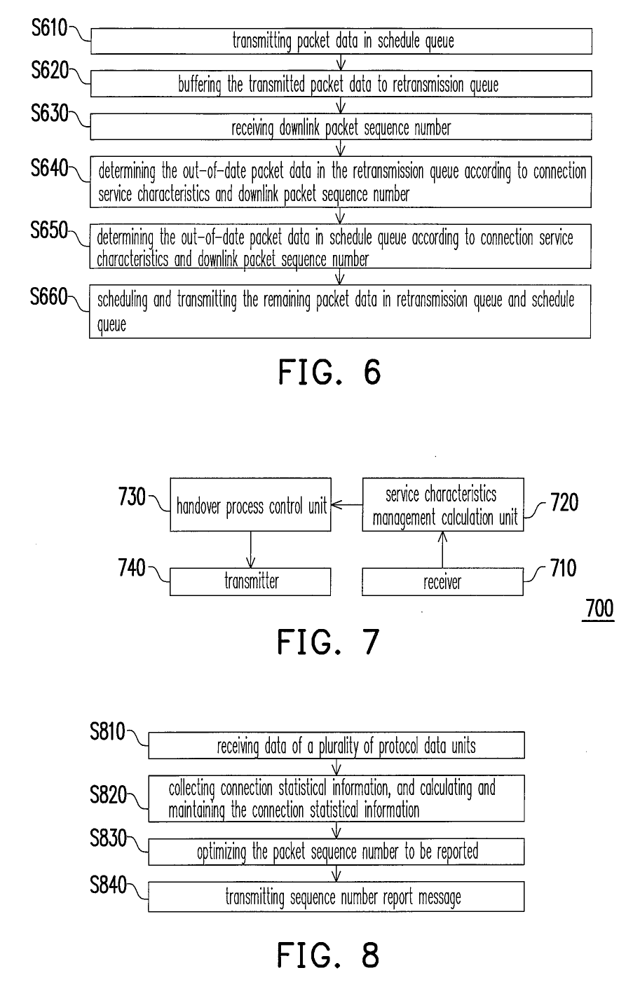

FIG. 6 is a schematic flow chart of a method for transmitting packet illustrated according to another embodiment of the present invention. Referring to FIG. 6, a connection-oriented network in a mobile communication system is provided. In order to avoid transmitting the out-of-date packets in real-time service during handover in the mobile communication system, a step of optimization is performed to delete the out-of-date packets.

First, the packet data in the schedule queue, i.e. the downlink packet data, is transmitted (step S610), and then the transmitted packet data is buffered to the retransmission queue (step S620). Because the transmitted packet data might be lost or damaged during transmission, the transmitted packet data is buffered in the retransmission queue so that the packet data, when lost, can be retransmitted. And then, the downlink packet sequence number, which is the downlink packet sequence number that the current connection is expecting to receive after handover, is received (step S630)

The out-of-date packets in the retransmission queue and the schedule queue are sequentially deleted via optimization according to the connection service characteristics belonging to the current packet being transmitted and the downlink packet sequence number (steps S640 and S650). After the out-of-date packets are deleted, the remaining packets in the retransmission queue and the schedule queue are scheduled and transmitted (step S660), the remaining packets includes real-time service packets and non-real-time service packets.

FIG. 7 is a block diagram of a mobile station illustrated according to an embodiment of the present invention. Referring to FIG. 7, the mobile station 700 that avoid transmitting the out-of-data packets during handover includes a receiver 710, a service characteristics management calculation unit 720, a handover process control unit 730 and a transmitter 740.

The receiver 710 is used to receive data of a plurality of protocol data units. The service characteristics management calculation unit 720 is coupled to the receiver 710, and collects connection statistical information according to the data received by the receiver 710, and calculates and maintains the connection statistical information. The connection statistical information includes, for example, cumulated service data unit (SDU) process time, cumulated SDU wait time, and service data unit sequence number, etc. Furthermore, the service characteristics management calculation unit 720 is also used to provide and maintain connection service type and parameters of connection service quality, etc.

The handover process control unit 730 is coupled to the service characteristics management calculation unit 720, and is used to obtain the connection service characteristics after handover, and to optimize the packet sequence number to be reported according to the connection service characteristics to obtain the downlink packet sequence number. For example, if the mobile station 700 needs to report the receiving state of the connection, the handover process control unit 730 will collect the connection service characteristics of the connections from the service characteristics management calculation unit 720, and the optimization is performed using formula (2), (3) and (4). The transmitter 740 transmits the sequence number report message including the downlink packet sequence number.

FIG. 8 is a schematic flow chart of a method for transmitting packet illustrated according to another embodiment of the present invention. Referring to FIG. 8, a mobile station in a mobile communication system is provided. The mobile station is used to avoid transmission of the out-of-date packets in real-time service during handover. Hereinafter, the detail steps of the method of the present invention will be further described in conjunction with the mobile station 700 described in the previous embodiment.

Referring to FIGS. 7 and 8, first, the receiver 710 receives data of the plurality of protocol data units (step S810). The protocol data units will be recombined with a service data unit, and the service characteristics management calculation unit 720 will collect the connection statistical information during the recombination, and calculate and maintain the connection statistical information (step S820).

The handover process control unit 730 sequentially compares according to the connection service characteristics collected from the service characteristics management calculation unit 720 to obtain a downlink packet sequence number, and transmits a sequence number report message through the transmitter 740 (step S840). The sequence number report message includes the downlink packet sequence number. Thus, the possibility of the transmission of the out-of-date packets can be effectively reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for transmitting packet in a mobile communication system, comprising:
transmitting a packet data in a schedule queue;
buffering the transmitted packet data to a retransmission queue;
receiving a downlink packet sequence number report;
determining out-of-date packet data in the retransmission queue according to a connection service characteristics belonging to current packet data being transmitted and the downlink packet sequence number report;
determining out-of-date packet data in the schedule queue according to the connection service characteristics belonging to the current packet data being transmitted and the downlink packet sequence number report; and
scheduling and transmitting non-out-of-date packet data in the retransmission queue and the schedule queue.

2. The method for transmitting packet of claim 1, wherein the downlink packet sequence number report is a report packet sequence number obtained through optimization according to the connection service characteristics belonging to the current packet data being received.

3. The method for transmitting packet of claim 1, wherein the non-out-of-date packet data in the retransmission queue and the schedule queue includes a real-time service packet data or a non-real-time service packet data or a real-time and a non-real-time service packet data.

4. The method for transmitting packet of claim 1, wherein the mobile communication system includes a mobile station and a network providing connection-oriented service, wherein the network providing connection-oriented service includes a first service station and a second service station, and wherein the steps of determining the out-of-date packet data in the retransmission queue and determining the out-of-date packet data in the schedule queue comprise:
optimizing a real-time or a non-real-time packet sequence number, or a real-time and a non-real-time packet sequence number to be forwarded using the first service station to obtain an optimized forwarding packet sequence number according to the downlink packet sequence number report or the connection service characteristics belonging to the current packet data being transmitted, or according to the downlink packet sequence number report and the connection service characteristics belonging to the current packet data being transmitted; and
determining the out-of-date packet data in the retransmission queue and determining the out-of-date packet data in the schedule queue according to the optimized forwarded packet sequence number.

5. The method for transmitting packet of claim 1, wherein the mobile communication system includes a mobile station and a network providing connection-oriented service, wherein the network providing connection-oriented service includes a first service station and a second service station, and wherein the steps of determining the out-of-date packet data in the retransmission queue and determining the out-of-date packet data in the schedule queue comprise:
optimizing a real-time or a non-real-time packet sequence number, or a real-time and a non-real-time packet sequence number to be transmitted using the second service station to obtain an optimized transmitting packet sequence number according to the downlink packet sequence number report or the connection service characteristics belonging to the current packet data being transmitted or according to the downlink packet sequence number report and the connection service characteristics belonging to the current packet data being transmitted; and
determining the out-of-date packet data in the retransmission queue and determining the out-of-date packet data in the schedule queue according to the optimized transmitting packet sequence number.

6. A method for transmitting packet in a mobile communication system including a mobile station and a network providing connection-oriented service including a first service station and a second service station, the method comprising:
receiving a handover notification message using the first service station;
receiving an entering network request message using the second service station;
responding with an entering network response message using the second service station;
receiving a sequence number report message including a downlink packet sequence number using the second service station;
optimizing a real-time or a non-real-time packet sequence number, or a real-time and a non-real-time packet sequence number to obtain an optimized forwarding packet sequence number using the first service station according to connection service characteristics belonging to current packet data being transmitted and the corresponding downlink packet sequence number;
forwarding the packet data to the second service station according to the optimized forwarding packet sequence number using the first service station; and
transmitting a downlink packet data using the second service station.

7. The method for transmitting packet of claim 6, further comprising a step of optimizing the packet sequence number to be reported using the mobile station to obtain the optimized downlink packet sequence number according to the connection service characteristics belonging to the current packet data being transmitted.

8. The method for transmitting packet of claim 6, wherein the connection service characteristics belonging to the current packet data being transmitted includes connection service type or parameters of connection service quality or connection statistical information, or the combination thereof.

9. The method for transmitting packet of claim 7, wherein the optimization of real-time packet sequence number to be reported is based on following equations:
$$\begin{matrix}{T}_{etd\_N} = \begin{matrix}{T}_{cqd\_N} + {T}_{eld} + {T}_{ehd} + {T}_{ecd} + {T}_{epd} + {T}_{eqd} \\ {T}_{emd} + {T}_{erd} + {T}_{esd} + {T}_{efd} + {T}_{ejd} ;\end{matrix} & ( 1 ) \\ {T}_{etd\_N} = {T}_{cp\_N} + {T}_{cw\_N} + {T}_{espd} + {T}_{end} ; & ( 2 ) \\ ⌈ \frac{{T}_{etd\_N}}{{T}_{f}} ⌉ \cdot {T}_{f} < {T}_{qosd} ; & ( 3 ) \\ {T}_{cw\_N} < {T}_{inactv} . & ( 4 )\end{matrix}$$
Wherein:
T_{etd}_{_{—}}_{N} represent estimated total delays of packet numbered as N;
T_{f} represents frame duration;
T_{cqd}_{_{—}}_{N} represents current queuing delays of packet numbered as N;
T_{qosd} represents delay requirement of quality of service (QoS) type belonging to the packet;
T_{ehd} represents estimated handover delays;
T_{eld} represents estimated relay delays;
T_{ecd} represents estimated codec processing delays;
T_{epd} represents estimated packetization delays;
T_{eqd}: estimated queuing delay;
T_{emd} represents estimated modulation & demodulation delays;
T_{erd} represents estimated radio frame wait times;
T_{esd}: estimated serial transmission time;
T_{efd} represents estimated IP Router & Switch forwarding delays;
T_{ejd} represents estimated receive jitter buffer delays;
T_{inactv} represents inactive time;
T_{cp}_{_{—}}_{N} represents cumulated process time of service data unit numbered as N;
T_{cw}_{_{—}}_{N} represents cumulated wait time of service data unit numbered as N;
T_{espd}: estimated service data unit processing delay; and
T_{end} represents estimated network processing delay;
wherein, packets that do not satisfy the in equation (3) are deleted and connections that do not satisfy the equation (4) do not report the packet sequence number.

10. The method for transmitting packet of claim 9, wherein the equation (4) is also used to determine whether reporting of the packet sequence number is required in non-real-time service.

11. A method for transmitting packet in a mobile communication system, wherein the mobile communication system includes a mobile station and a network providing connection-oriented service including a first service station and a second service station, the method comprising:
receiving a handover notification message using the first service station;
receiving an entering network request message using the second service station;
responding with an entering network response message using the second service station;
receiving a sequence number report message including a downlink packet sequence number using the second service station;
optimizing a real-time or a non-real-time packet sequence number, or a real-time and a non-real-time packet sequence number to be transmitted using the second service station to obtain an optimized transmitting packet sequence number according to a connection service characteristics belonging to current packet data being transmitted and the corresponding downlink packet sequence number; and
transmitting a downlink packet data using the second service station according to the optimized transmitting packet sequence number.

12. The method for transmitting packet of claim 11, further comprising a step of optimizing the packet sequence number to be forwarded using the first service station to obtain an optimized forwarding packet sequence number according to the connection service characteristics belonging to the current packet data; and
forwarding an real-time service packet data to the second service station using the first service station according to the optimized forwarding packet sequence number.

13. The method for transmitting packet of claim 11, wherein the connection service characteristics belonging to the current packet data includes connection service type, parameters of connection service quality, and connection statistical information.

14. The method for transmitting packet of claim 12, wherein the optimization of real-time packet sequence number to be forwarded is based on following equations:
$$\begin{matrix}{T}_{etd\_N} = \begin{matrix}{T}_{cqd\_N} + {T}_{eld} + {T}_{ehd} + {T}_{ecd} + {T}_{epd} + {T}_{eqd} \\ {T}_{emd} + {T}_{erd} + {T}_{esd} + {T}_{efd} + {T}_{ejd} ;\end{matrix} \\ and & ( 1 ) \\ ⌈ \frac{{T}_{etd\_N}}{{T}_{f}} ⌉ \cdot {T}_{f} < {T}_{qosd} , & ( 2 )\end{matrix}$$
Wherein:
T_{etd}_{_{—}}_{N} represents estimated total delays of packet numbered as N;
T_{f} represents frame duration;
T_{cqd}_{_{—}}_{N} represents current queuing delays of packet numbered as N;
T_{qosd} represents delay requirement of quality of service (QoS) type belonging to packet;
T_{ehd} represents estimated handover delays;
T_{eld} represents estimated relay delays;
T_{ecd} represents estimated codec processing delays;
T_{epd} represents estimated packeting delays;
T_{eqd} represents estimated queuing delay;
T_{emd} represents estimated modulation & demodulation delays;
T_{erd} represents estimated radio frame wait times;
T_{esd} represents estimated serial transmission time;
T_{efd} represents estimated IP Router & Switch forwarding delays;
T_{ejd} represents estimated receive jitter buffer delays;
wherein, the packets that do not satisfy the equation (2) are deleted.

15. The method for transmitting packet of claim 11, wherein the second service station transmits the downlink packet data according to the transmitting packet sequence number, including: transmitting real-time service packet data, or transmitting non-real-time service packet data or real-time and non-real-time service packet data.

16. A method for transmitting packets in a mobile communication system, wherein the mobile communication system includes a mobile station and a network providing connection-oriented service including a first service station and a second service station, the method comprising:
receiving a handover notification message using the first service station;
receiving an entering network request message using the second service station;
responding with an entering network response message using the second service station;
optimizing a real-time packet sequence number to be forwarded using the first service station to obtain an optimized forwarding packet sequence number according to a connection service characteristics belonging to the current packet data being transmitted;
transmitting a real-time service packet data to the second service station using the first service station according to the optimized forwarding packet sequence number;
receiving a sequence number report message including a downlink packet sequence number using the second service station; and
transmitting the real-time service packet data using the second service station.

17. The method for transmitting packet of claim 16, further comprising:
transmitting a request for non-real-time service packet data to the first service station using the second service station;
forwarding a non-real-time service packet data to the second service station using the first service station; and
transmitting the non-real-time service packet data using the second service station.

18. The method for transmitting packet of claim 16, wherein the connection service characteristics belonging to current packet data being transmitted includes connection service type or parameters of connection service quality or connection statistical information, or combination thereof.

19. The method for transmitting packet of claim 16, wherein the optimization of real-time packet sequence number to be forwarded is based on following equations:
$$\begin{matrix}{T}_{etd\_N} = \begin{matrix}{T}_{cqd\_N} + {T}_{eld} + {T}_{ehd} + {T}_{ecd} + {T}_{epd} + {T}_{eqd} \\ {T}_{emd} + {T}_{erd} + {T}_{esd} + {T}_{efd} + {T}_{ejd} ;\end{matrix} \\ and & ( 1 ) \\ ⌈ \frac{{T}_{etd\_N}}{{T}_{f}} ⌉ \cdot {T}_{f} < {T}_{qosd} , & ( 2 )\end{matrix}$$
wherein:
T_{etd}_{_{—}}_{N} represents estimated total delays of packet numbered as N;
T_{f} represents frame duration;
T_{cqd}_{_{—}}_{N} represents current queuing delays of packet numbered as N;
T_{qosd} represents delay requirement of quality of service (QoS) type belonging to packet;
T_{ehd} represents estimated handover delays;
T_{eld} represents estimated relay delays;
T_{ecd} represents estimated codec processing delays;
T_{epd} represents estimated packeting delays;
T_{eqd} represents estimated queuing delay;
T_{emd} represents estimated modulation & demodulation delays;
T_{erd} represents estimated radio frame wait times;
T_{esd} represents estimated serial transmission time;
T_{efd} represents estimated IP Router & Switch forwarding delays; and
T_{ejd} represents estimated receive jitter buffer delays;
wherein, the packets that do not satisfy the equation (2) are deleted.

20. A system for mobile communication, comprising:
a mobile station, for transmitting or receiving a handover notification message and transmitting an entering network request message; and
a network providing connection-oriented service, comprising:
a first service station, for receiving or transmitting the handover notification message; and
a second service station, for receiving the entering network request message and responding to the mobile station with an entering network response message, wherein the second service station receives a sequence number report message including a downlink packet sequence number transmitted by the mobile station;
wherein the first service station optimizes a real-time packet sequence number to be forwarded according to a connection service characteristics belonging to current packet data being transmitted and the corresponding downlink packet sequence number to obtain an optimized forwarding packet sequence number, and transmits a packet data to the second service station according to the optimized forwarding packet sequence number so that the second service station transmits a downlink packet data to the mobile station.

21. The system for mobile communication of claim 20, wherein the mobile station optimizes the packet sequence number to be reported according to the connection service characteristics belonging to the current packet data to obtain the downlink packet sequence number.

22. The system for mobile communication of claim 20, wherein the connection service characteristics belonging to the current packet data includes connection service type or parameters of connection service quality or connection statistical information, or combination thereof.

23. A mobile station, comprising:
a receiver, for receiving data of a plurality of protocol data units;
a service characteristics management calculation unit, for providing and maintaining connection service characteristics including a connection service type or a connection service quality parameter or a connection statistical information or combination thereof, wherein the service characteristics management calculation unit is coupled to the receiver to collect connection statistical information according to data received by the receiver, and calculates and maintains the connection statistical information;
a handover process control unit, coupled to the service characteristics management calculation unit, for obtaining the connection service characteristics after handover and optimizing the packet sequence number to be reported according to the connection service type to obtain a downlink packet sequence number; and
a transmitter, for transmitting a sequence number report message including the downlink packet sequence number.

24. The mobile station of claim 23, wherein the connection statistical information includes cumulated processing time of service data unit or cumulated wait time of service data unit or sequence number of service data unit, or combination thereof.

25. A method for transmitting packet in a mobile station in a system for mobile communication, comprising:
receiving data of a plurality of protocol data units;
collecting a connection service characteristics according to the received data, and calculating and maintaining the connection service characteristics including a connection service type or a connection service quality parameter or a connection statistical information, or combination thereof;
optimizing a sequence number of a packet to be reported according to the connection service type to obtain a downlink packet sequence number; and
transmitting a sequence number report message including the downlink packet sequence number.

26. The method for transmitting packet of claim 25, wherein the connection statistical information includes cumulated process time of service data unit or cumulated wait time of service data unit or sequence number of service data unit, or combination thereof.

27. The method for transmitting packet of claim 25, wherein the optimization of the packet sequence number to be reported is based on following equations:
$$\begin{matrix}{T}_{etd\_N} = {T}_{cp\_N} + {T}_{cw\_N} + {T}_{espd} + {T}_{end} ; & ( 1 ) \\ ⌈ \frac{{T}_{etd\_N}}{{T}_{f}} ⌉ \cdot {T}_{f} < {T}_{qosd} ; \\ and & ( 2 ) \\ {T}_{cw\_N} < {T}_{inactv} , & ( 3 )\end{matrix}$$
Wherein:
T_{etd}_{_{—}}_{N} represents estimated total delays of packet numbered as N;
T_{f} represents frame duration;
T_{qosd} represents delay requirement of quality of service (QoS) type belonging to packet;
T_{inactv} represents connection inactive time;
T_{cp}_{_{—}}_{N} represents cumulated process time of service data unit numbered as N;
T_{cw}_{_{—}}_{N} represents cumulated wait time of service data unit numbered as N;
T_{espd} represents estimated service data unit processing delay; and
T_{end} represents estimated network processing delay;
wherein, the packets that do not satisfy the equation (2) are deleted and the connections that do not satisfy the equation (3) do not report the packet sequence number.

28. The method for transmitting packet of claim 27, wherein the equation (3) is also used to determine whether the reporting of the packet sequence number is required in non-real-time service.
